(19) United States
(12) Patent Application Publication
(10) Pub. No.: US 2019/0337618 A1
(43) Pub. Date: Nov. 7, 2019

(54) UAV SYSTEM

(71) Applicant: SZ DJI TECHNOLOGY CO., LTD., Shenzhen (CN)

(72) Inventors: Daijun ZHOU, Shenzhen (CN); Ran LIAO, Shenzhen (CN)

(21) Appl. No.: 16/453,191

(22) Filed: Jun. 26, 2019

Related U.S. Application Data
(63) Continuation of application No. PCT/CN2016/112551, filed on Dec. 28, 2016.

(51) Int. Cl. B64C 39/02; B64C 1/22

(52) U.S. Cl. CPC B64C 39/024; B64C 2201/042; B64C 2201/00; B64C 1/22

(57) ABSTRACT

An unmanned aerial vehicle (UAV) system includes a first device including a housing space, a second device configured to be housed and held at the housing space, and a retaining structure configured to hold the second device at the housing space.

### CROSS-REFERENCES TO RELATED APPLICATION

This application is a continuation of International Application No PCT/CN2016/112551, filed on Dec. 28, 2016, the entire contents of which are incorporated herein by reference.

### TECHNICAL FIELD

The present disclosure generally relates to the field of unmanned aerial vehicle technology and, more particularly, to an unmanned aerial vehicle system.

### BACKGROUND

An unmanned aerial vehicle (UAV), sometimes called a drone, is an aircraft carrying no human pilots or passengers and controlled by a radio remote controller and a self-contained-program-control device. From a technical perspective, the UAV can be classified into: unmanned fixed-wing aircraft, unmanned vertical take-off/landing aircraft, unmanned airship, unmanned helicopter, unmanned multi-rotor aircraft, unmanned parachute aircraft, etc. From an application perspective, the UAV can be classified into military use and civilian use. For military use, the UAV is classified into surveillance aircraft and target craft. In terms of civilian use, there are real needs of the UAV in industrial applications. So far, applications in fields, such as aerial photography, agriculture, plant protection, self-portrait photography, express transportation, emergency rescue, wildlife observation, infectious disease monitoring, mapping, news report, power inspection, disaster relief, movie and television shooting, romance creation, greatly extended the use of the UAV. Developed countries are also proactively expanding the industrial applications and developing technologies of the UAV.

### SUMMARY OF THE DISCLOSURE

One aspect of the present disclosure provides an unmanned aerial vehicle (UAV) system. The UAV system includes a first device including a housing space, a second device configured to be housed and held at the housing space, and a retaining structure configured to hold the second device at the housing space.

### BRIEF DESCRIPTION OF THE DRAWINGS

FIG. 1 illustrates a schematic structural diagram of an unmanned aerial vehicle (UAV).

FIG. 2 illustrates a schematic perspective view of an example UAV system consistent with the disclosure.

FIG. 3 illustrates a schematic exploded view showing the example UAV system of FIG. 2.

FIG. 4 illustrates a schematic perspective view of another example UAV system consistent with the disclosure.

FIG. 5 illustrates a schematic exploded view showing the example UAV system of FIG. 4.

FIG. 6 illustrates a schematic perspective view of another example UAV system consistent with the disclosure.

FIG. 7 illustrates a schematic exploded view showing the example UAV system of FIG. 6.

FIG. 8 illustrates a schematic perspective view of another example UAV system consistent with the disclosure.

FIG. 9 illustrates a schematic exploded view showing the example UAV system of FIG. 8.

FIG. 10 illustrates a schematic perspective view of another example UAV system consistent with the disclosure.

FIG. 11 illustrates a schematic exploded view showing the example UAV system of FIG. 10.

FIG. 12 illustrates a schematic perspective view of another example UAV system consistent with the disclosure.

FIG. 13 illustrates a schematic exploded view showing the example UAV system of FIG. 12.

FIG. 14 illustrates a schematic perspective view of another example UAV system consistent with the disclosure.

FIG. 15 illustrates a schematic diagram showing an example first state of the example UAV system of FIG. 14.

FIG. 16 illustrates a schematic diagram showing an example second state of the example UAV system of FIG. 14.

### DETAILED DESCRIPTION

Reference will now be made in detail to example embodiments of the disclosure, which are illustrated in the accompanying drawings. Hereinafter, embodiments consistent with the disclosure will be described with reference to drawings. Wherever possible, the same reference numbers will be used throughout the drawings to refer to the same or like parts. The described embodiments are some but not all of the embodiments of the present disclosure. Based on the disclosed embodiments, persons of ordinary skill in the art may derive other embodiments consistent with the present disclosure, all of which are within the scope of the present disclosure. Further, in the present disclosure, embodiments and features of the embodiments may be combined as long as there is no conflict.

The terminology used in the disclosure is for the purpose of describing the embodiments, and is not intended to limit the disclosure. The singular forms “a,” “the,” and “said” also include plural forms, unless the context clearly indicates otherwise. Further, term “and/or” as used herein refers to and encompasses any and all possible combinations of one or more of the associated listed items.

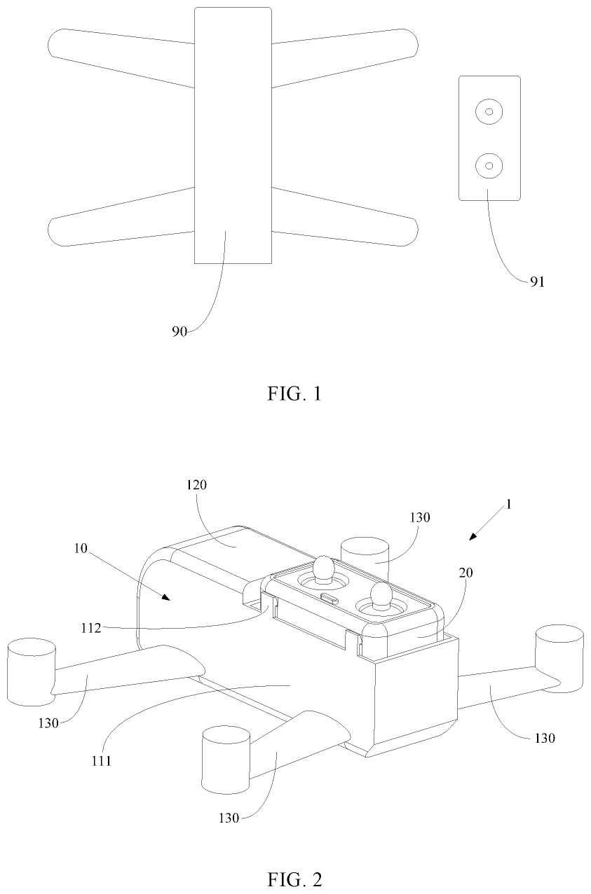

FIG. 1 illustrates a schematic structural diagram of an unmanned aerial vehicle (UAV) consistent with the disclosure. As shown in FIG. 1, the UAV includes a UAV body 90 (aerial terminal) and a remote controller 91 (ground terminal) for controlling the UAV body 90.

A UAV system consistent with the present disclosure can include a first device and a second device that are connected with each other through wireless communication. The first device includes a housing space, and the second device is housed (contained) and held at the housing space (e.g., in the housing space). The UAV system may also include a retaining structure for holding the second device in the housing space.

The UAV system consistent with the present disclosure may electromechanically couple the first device with the second device, and may house the second device with the retaining structure of the first device to integrate the first device and the second device for ease of carrying.

In some embodiments, the first device may be a UAV body, and the second device may be a remote controller for controlling the UAV body, e.g., the remote controller may be placed at the UAV body. In some embodiments, the remote controller may be a mobile communication device, such as a mobile phone or a table computer. The mobile communication device, serving as the remote controller, may be housed at the UAV body.

In some other embodiments, the second device may be the UAV body, and the first device may be the remote controller for controlling the UAV body, e.g., the UAV body may be placed at the remote controller. In some embodiments, the remote controller may be a mobile communication device, such as a mobile phone or a tablet computer. The UAV body may be housed at the mobile communication device that serves as the remote controller.

The following will set forth the UAV system consistent with the present disclosure with reference to the accompanying drawings and specific embodiments. In the case where no conflict occurs, the following embodiments and features of the embodiments can be combined with each other.

The following embodiments will illustrate the UAV system consistent with the present disclosure by taking the remote controller placed at the UAV body as an example.

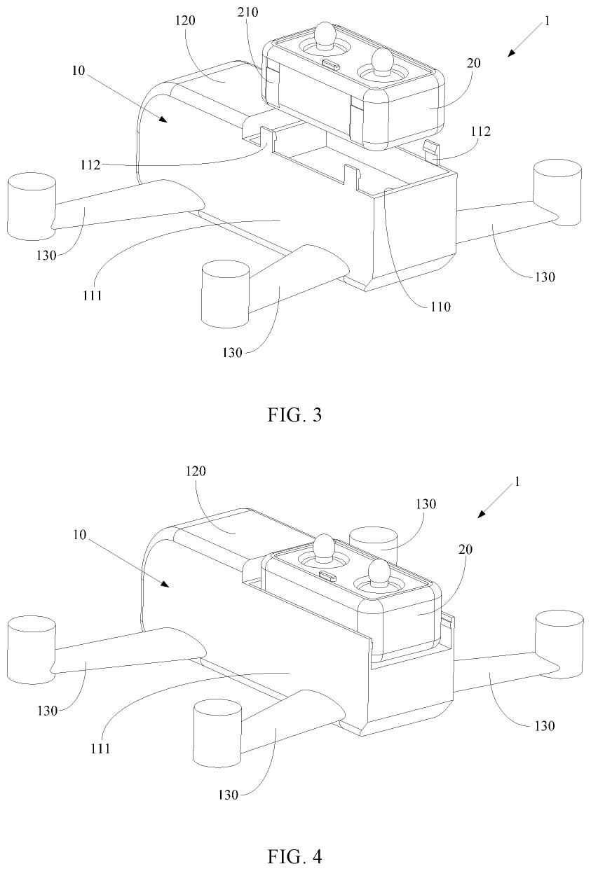

FIG. 2 illustrates a schematic perspective view of an example UAV system 1 consistent with the disclosure. FIG. 3 illustrates a schematic exploded view showing the example UAV system 1 of FIG. 2. As shown in FIG. 2, the first device of the UAV system 1 is the UAV body 10, the second device is the remote controller 20 controlling the UAV body 10, e.g., the remote controller 20 is housed at the UAV body 10. The UAV body 10 may maintain wireless communication with the remote controller 20. As shown in FIG. 3, the UAV body 10 includes a housing space 110. The remote controller 20 is housed and held at the housing space 110 of the UAV body 10, such that the UAV body 10 and the remote controller 20 can be integrally housed together for ease of carrying.

In some embodiments, the UAV body 10 includes a fuselage 120 and a propeller assembly 130 connected to the fuselage 120. The housing space 110 is arranged at the fuselage 120.

The housing space 110 of the UAV body 10 serves as a housing groove, and the remote controller 20 is housed and held at the housing groove. The retaining structure includes snapping members 112 arranged at end portions of two opposing groove sidewalls 111 of the housing groove (e.g., top portions of the groove sidewalls 111 as shown in FIGS. 2 and 3), and snapping slots 210 arranged at the two opposing sidewalls of the remote controller 20. The snapping slots 210 are configured to match the snapping members 112 of the housing groove of the UAV body 10.

As shown in FIG. 3, the remote controller 20 can be affixed to the snapping members 112 by engaging to the snapping slots 210, thereby being housed and held at the housing groove of the UAV body 10. When the remote controller 20 is being removed from the UAV body 10, the snapping slots 210 can be disengaged from the snapping members 112 of the housing groove of the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to the larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and then the remote controller 20 may be housed at the UAV body 10. Such arrangement can further improve housing efficiency.

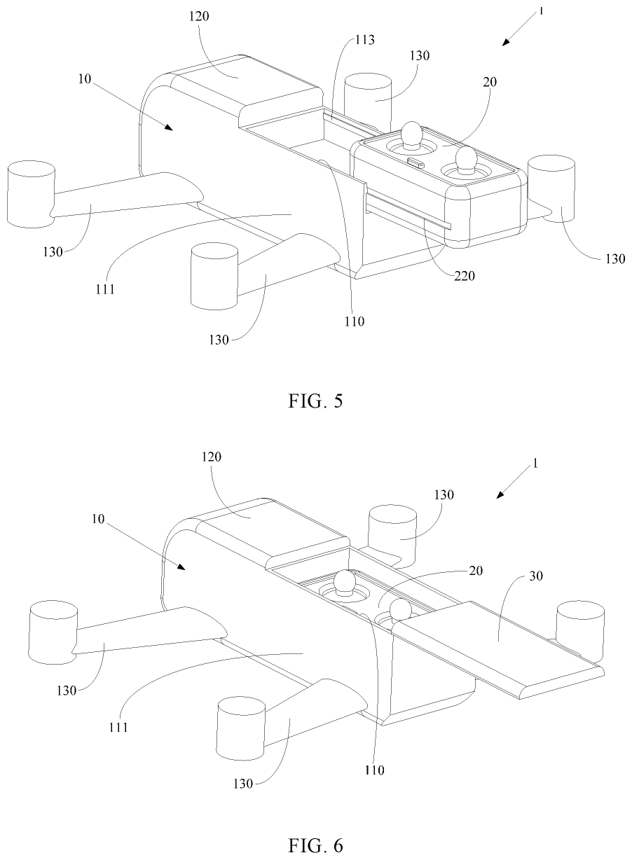

FIG. 4 illustrates a schematic perspective view of another example UAV system 1 consistent with the disclosure. FIG. 5 illustrates a schematic exploded view showing the example UAV system 1 of FIG. 4. In some embodiments, as shown in FIG. 4 and FIG. 5, the first device of the UAV system 1 is the UAV body 10, and the second device is the remote controller 20 controlling the UAV body 10, e.g., the remote controller 20 is placed at the UAV body 10. The UAV body 10 may maintain wireless communication with the remote controller 20. The UAV body 10 includes a housing space 110, and the remote controller 20 is housed and held at the housing space 110 of the UAV body 10 via the retaining structure, such that the UAV body 10 and the remote controller 20 can be integrally housed together for ease of carrying. In some embodiments, as shown in FIG. 4 and FIG. 5, the UAV body 10 includes a fuselage 120, and a propeller assembly 130 connected to the fuselage 120. The housing space 110 is arranged at the fuselage 120.

As shown in FIG. 4 and FIG. 5, the housing space 110 of the UAV body 10 serves as the housing groove, and the remote controller 20 is housed and held at the housing groove. The retaining structure includes first sliding slots 113, arranged at inner sides of two opposing groove sidewalls 111 of the housing groove, and first sliding ribs 220, arranged at two opposing sidewalls of the remote controller 20. The first sliding ribs 220 are configured to match the first sliding slots 113 of the housing groove of the UAV body 10. Further, the inner sides of the two opposing groove sidewalls 111 of the housing groove of the UAV body 10 each includes a first sliding slot 113, arranged along the length direction of the groove sidewalls 111. Correspondingly, the two opposing sidewalls of the remote controller 20 each includes a sliding rib 220, arranged along the length direction of the remote controller 20.

As shown in FIG. 5, the remote controller 20 can be slid into or out of the first sliding slots 113 of the housing groove of the UAV body 10 via the first sliding ribs 220, thereby being housed and held at the housing groove of the UAV body 10. When the remote controller 20 is being removed from the UAV body 10, the first sliding ribs 220 can be disengaged from the first sliding slots 113 of the housing groove of the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when a battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and the remote controller 20 may be housed at the UAV body 10. In these embodiments, the UAV body 10 can house not only the remote controller 20, but also the battery and/or the gimbal that can be housed at the remote controller 20. Such arrangement can further improve housing efficiency.

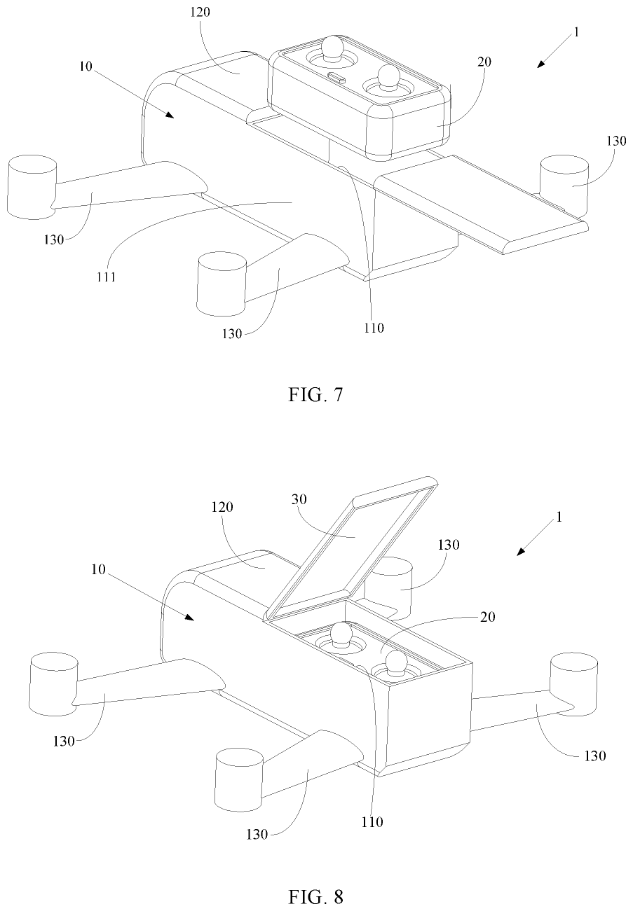

FIG. 6 illustrates a schematic perspective view of another example UAV system consistent with the disclosure. FIG. 7 illustrates a schematic exploded view showing the example UAV system of FIG. 6. In some embodiments, as shown in FIG. 6 and FIG. 7, the first device of the UAV system 1 is the UAV body 10, the second device is the remote controller 20 controlling the UAV body 10, e.g., the remote controller 20 is housed at the UAV body 10. The UAV body 10 may maintain wireless communication with the remote controller 20. The UAV body 10 includes a housing space 110. The remote controller 20 is housed and held at the housing space 110 of the UAV body 10 via the retaining structure, such that the UAV body 10 and the remote controller 20 can be integrally housed together for ease of carrying. In some embodiments, as shown in the FIG. 6 and FIG. 7, the UAV body 10 includes a fuselage 120 and a propeller assembly 130 connected to the fuselage 120. The housing space 110 is arranged at the fuselage 120.

As shown in FIG. 6 and FIG. 7, the housing space 110 of the UAV body 10 serves as the housing groove, and the remote controller 20 is housed and held at the housing groove. The retaining structure includes a cover plate 30 movably connected to the UAV body 10 and configured to cover an opening of the housing groove of the UAV body 10. Further, the retaining structure also includes second sliding slots, arranged at the end portions of the two opposing groove sidewalls 111 of the housing groove of the UAV body 10, and second sliding ribs, arranged at the two opposing sides of the cover plate 30. The second sliding ribs are configured to match the second sliding slots on the housing groove of the UAV body 10. In some embodiments, the end portions of the two opposing groove sidewalls 111 of the housing groove of the UAV body 10 may each include a second sliding slot, arranged along the length direction of the groove sidewalls 111. Correspondingly, the two opposing sides of the cover plate 30 may also each include a second sliding rib, arranged along the length direction of the cover plate 30.

As shown in FIG. 6, the opening of the housing groove of the UAV body 10 can be enclosed to retain the remote controller 20 at the housing groove of the UAV body 10, after the remote controller 20 is housed at the housing groove of the body 10 and the second sliding ribs of the cover plate 30 slide into the second sliding slots of the housing groove of the UAV body 10. When the remote controller 20 is being removed from the UAV body 10, the remote controller 20 can be removed from the housing groove of the UAV body 10, by sliding the second sliding ribs of the cover plate 30 out of the second sliding slots of the housing groove of the UAV body 10 to open the housing groove of the UAV body 10 and expose the remote controller 20.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and the remote controller 20 may be housed at the UAV body 10. Such arrangement can further improve housing efficiency.

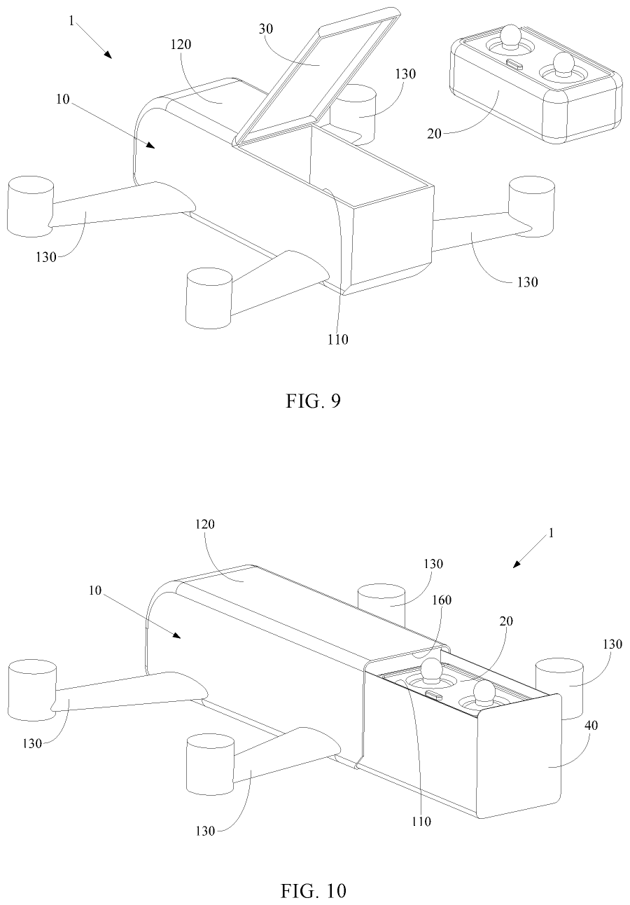

FIG. 8 illustrates a schematic perspective view of another example UAV system 1 consistent with the disclosure. FIG. 9 illustrates a schematic exploded view showing the example UAV system 1 of FIG. 8. In some embodiments, as shown in FIG. 8 and FIG. 9, the first device of the UAV system 1 is the UAV body 10, and the second device is the remote controller 20 controlling the UAV body 10, e.g., the remote controller 20 is housed at the UAV body 10. The UAV body 10 may maintain wireless communication with the remote controller 20. The UAV body 10 includes a housing space 110. The remote controller 20 is housed and held at the housing space 110 of the UAV body 10, such that the UAV body 10 and the remote controller 20 can be integrally housed together for ease of carrying. In some embodiments, the UAV body 10 includes a fuselage 120, and a propeller assembly 130 connected to the fuselage 120. The housing space 110 is arranged at the fuselage 120.

As shown in FIG. 8 and FIG. 9, the housing space 110 serves as the housing groove, and the remote controller 20 is housed and held at the housing groove. The retaining structure includes a cover plate 30 movably connected to the UAV body 10 and configured to cover an opening of the housing groove of the UAV body 10. Further, the retaining structure may also include a pivot shaft arranged at an end of the housing groove of the UAV body 10, and the cover plate 30 may be rotatably connected to the pivot shaft. In some embodiments, the pivot shaft may be arranged at an end of the housing groove close to the middle of the UAV body 10.

As shown in FIG. 8, the remote controller 20 can be retained at the housing groove of the UAV body 10, after the remote controller 20 is housed at the housing groove of the UAV body 10 and the cover plate 30 is turned downwards to close the housing groove of the UAV body 10. When the remote controller 20 is being removed from the UAV body 10, the cover plate 30 can be turned upwards to open the housing groove of the UAV body 10 and expose the remote controller 20, such that the remote controller 20 can be removed from the housing groove of the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and then the remote controller 20 may be housed at the UAV body 10. Such arrangement can further improve housing efficiency.

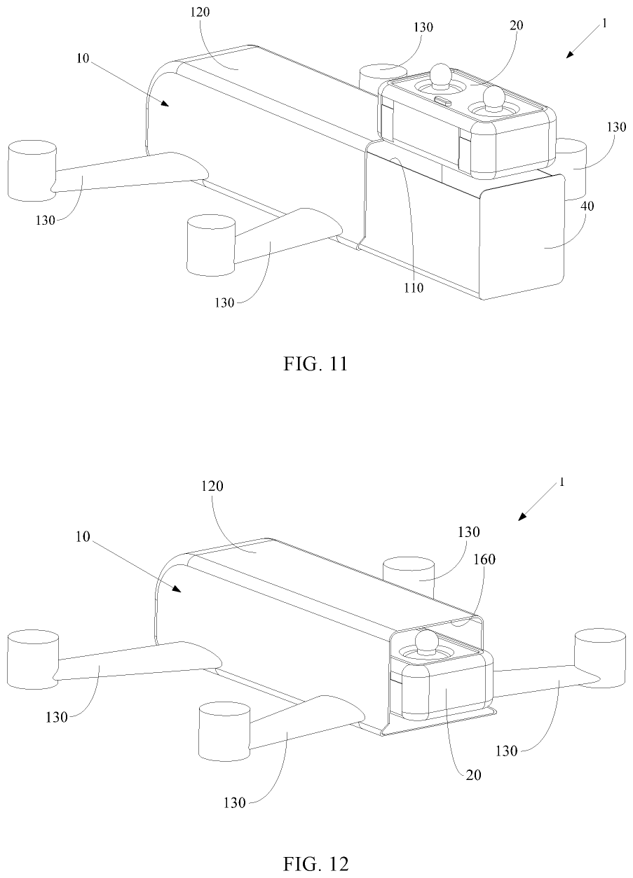

FIG. 10 illustrates a schematic perspective view of another example UAV system 1 consistent with the disclosure. FIG. 11 illustrates a schematic exploded view showing the example UAV system 1 of FIG. 10. In some embodiments, as shown in FIG. 10 and FIG. 11, the first device of the UAV system 1 is the UAV body 10, the second device is the remote controller 20 controlling the UAV body 10, e.g., the remote controller 20 is housed at the UAV body 10. The UAV body 10 may maintain wireless communication with the remote controller 20. The UAV body 10 includes a housing space 110. The remote controller 20 is housed and held at the housing space 110 of the UAV body 10, such that the UAV body 10 and the remote controller 20 can be integrally housed together for ease of carrying. In some embodiments, as shown in FIG. 10 and FIG. 11, the UAV body 10 includes a fuselage 120, and a propeller assembly 130 connected to the fuselage 120. The housing space 110 is arranged at the fuselage 120.

As shown in FIG. 11, the retaining structure also includes a drawer-box structure 40 housed at the UAV body 10, and the housing space 110 is arranged at the drawer-box structure 40. One side of the UAV body 10 (e.g., the tail end of the UAV body 10) includes an opening 160, through which the drawer-box structure 40 can be pulled from or pushed back to the UAV body 10.

As shown in FIG. 10, the remote controller 20 can be retained at the UAV body 10, after the remote controller 20 is housed at the housing space 110 of the drawer-box structure 40 and the drawer box structure 40 is pushed back to the UAV body 10 via the opening 160. When the remote controller 20 is being removed from the UAV body 10, the drawer-box structure 40 can be pulled from the UAV body 10 via the opening 160, such that the remote controller 20 can be removed from the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and then the remote controller 20 may be housed at the UAV body 10. Such arrangement can further improve housing efficiency.

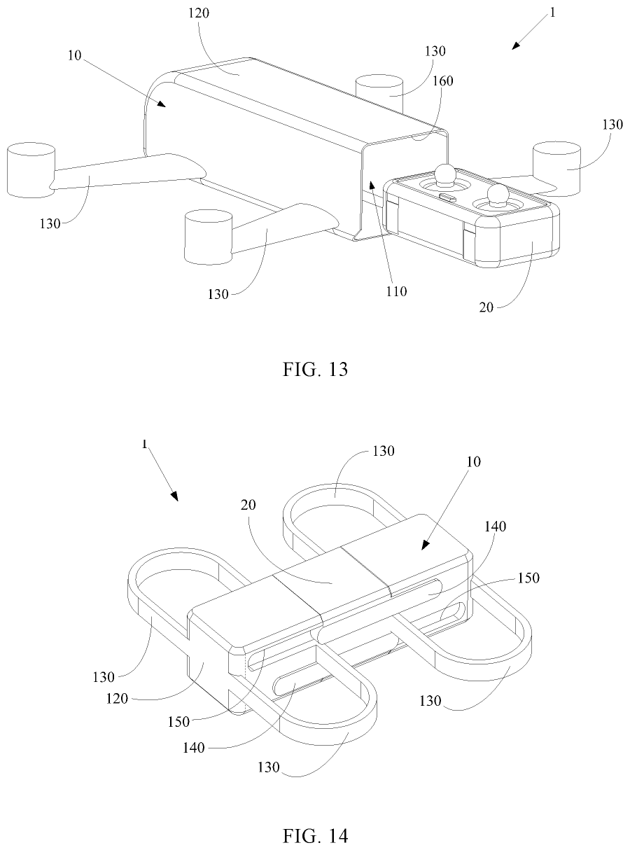

FIG. 12 illustrates a schematic perspective view of another example UAV system 1 consistent with the disclosure. FIG. 13 illustrates a schematic exploded view showing the example UAV system 1 of FIG. 12. In some embodiments, as shown in FIG. 12 and FIG. 13, the first device of the UAV system 1 is the UAV body 10, and the second device is the remote controller 20 controlling the UAV body 10, e.g., the remote controller 20 is housed at the UAV body 10. The UAV body 10 may maintain wireless communication with the remote controller 20. The UAV body 10 includes a housing space 110. The remote controller 20 is housed and held at the housing space 110 of the UAV body 10, such that the UAV body 10 and the remote controller 20 can be integrally housed together for ease of carrying. In some embodiments, as shown in FIG. 12 and FIG. 13, the UAV body 10 includes a fuselage 120, and a propeller assembly 130 connected to the fuselage 120. The housing space 110 is arranged at the fuselage 120.

As shown in FIG. 12 and FIG. 13, the housing space 110 is formed to the UAV body 10. The retaining structure may include third sliding slots arranged at inner walls of two opposing sidewalls of the UAV body 10, and third sliding ribs arranged at the two opposing sidewalls of the remote controller 20. The third sliding ribs are configured to match the third sliding slots on the inner walls of the two opposing sidewalls of the UAV body 10. One side (e.g., the tail end of the UAV body 10) of the UAV body 10 also includes an opening 160, through which the remote controller 20 can be pulled from or pushed back to the housing space 110 of the UAV body 10. Further, the two inner walls of the two opposing sidewalls of the UAV body 10 may each include a third sliding slot, arranged along the length direction of the UAV body 10. Correspondingly, the two opposing sidewalls of the remote controller 20 may each include a sliding rib, arranged along the length direction of the remote controller 20.

As shown in FIG. 13, the remote controller 20 can be retained at the UAV body 10 via the opening 160, by pushing the remote controller 20 back to the housing space 110 of the UAV body 10. When the remote controller 20 is being removed from the UAV body 10, the remote controller 20 can be pulled from the housing space 110 of the UAV body 10 via the opening 160, thus removing the remote controller 20 from the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and then the remote controller 20 may be housed at the UAV body 10. Such arrangement can further improve housing efficiency.

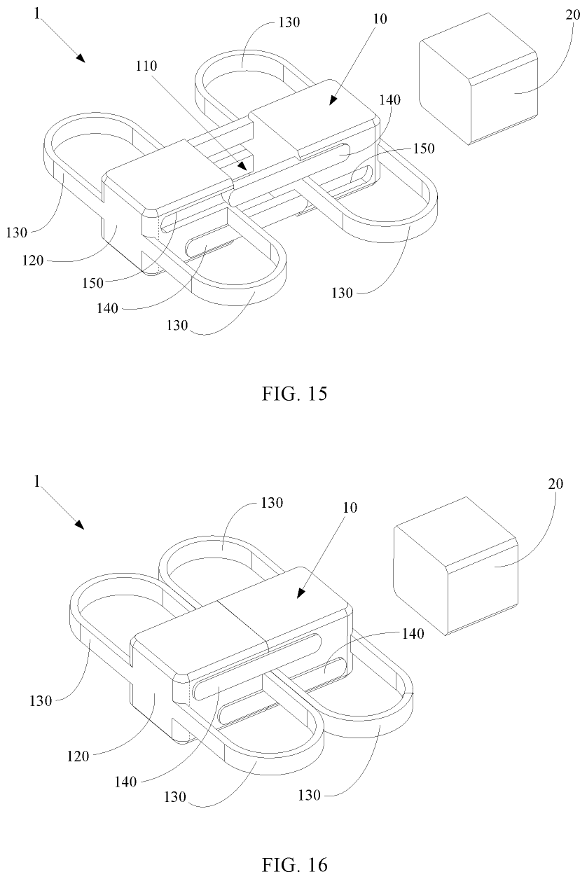

FIG. 14 illustrates a schematic perspective view of another example UAV system 1 consistent with the disclosure. FIG. 15 illustrates a schematic diagram showing an example first state of the example UAV system 1 of FIG. 14. FIG. 16 illustrates a schematic diagram showing an example second state of the example UAV system 1 of FIG. 14. In some embodiments, as shown in FIGS. 14-16, the first device of the UAV system 1 is the UAV body 10, and the second device is the remote controller 20 controlling the UAV body 10, e.g., the remote controller 20 is housed at the UAV body 10. The UAV body 10 may maintain wireless communication with the remote controller 20. The UAV body 10 includes a housing space 110. The remote controller 20 is housed and held at the housing space 110 of the UAV body 10, such that the UAV body 10 and the remote controller 20 can be integrally housed together for ease of carrying. In some embodiments, as shown in FIGS. 14-16, the UAV body 10 includes a fuselage 120, and a propeller assembly 130 connected to the fuselage 120. The housing space 110 is arranged at the fuselage 120.

As shown in FIGS. 14-16, the body 10 can be locally or globally deformed. After the UAV body 10 is deformed to release the housing space 110, the remote controller 20 can be housed and held at the UAV body 10. Further, side portions of the UAV body 10 include sliding ribs 140 and sliding slots 150 matching each other. As shown in FIG. 15, by cooperation of the sliding ribs 140 and the sliding slots 150, the UAV body 10 can be stretched to release the housing space 110. Thus, as shown in FIG. 14, the remote controller 20 can be housed and held at the UAV body 10.

In some embodiments, the UAV body 10 may include a first charging interface, and the remote controller 20 may include a second charging interface to pair and connect with the first charging interface of the UAV body 10. When the remote controller 20 is housed at the UAV body 10, the second charging interface of the remote controller 20 may be connected to the first charging interface of the UAV body 10. When a battery capacity of the UAV body 10 is insufficient, due to a lower power consumption of the remote controller 20, a battery of the remote controller 20 can charge a battery of the UAV body 10. In some embodiments, when the battery capacity of the remote controller 20 is insufficient, due to a larger battery capacity of the UAV body 10, the battery of the UAV body 10 can charge the battery of the remote controller 20.

In some embodiments, the UAV body 10 may include a first data interface, and the remote controller 20 may include a second data interface to pair and connect with the first data interface. When the remote controller 20 is housed at the UAV body 10, the second data interface of the remote controller 20 may be connected with the first data interface of the UAV body 10, such that data can be transmitted between the UAV body 10 and the remote controller 20. For example, data synchronization can be achieved among specific devices (e.g., a black box) of the UAV body 10 and the remote controller 20. In some embodiments, the UAV body 10 may transmit the data (e.g., flight data, photographed photos and videos, etc.) to the remote controller 20, and the remote controller 20 (via the mobile device or a private network) may synchronize with the cloud and transmit the data to the cloud.

In some embodiments, the remote controller 20 may include a plurality of remote-controller components that are detachable from each other, and the housing space 110 of the UAV body 10 may include a plurality of housing subspaces corresponding to the plurality of remote-controller components of the remote controller 20. The plurality of remote-controller components of the remote controller 20 may be housed at the corresponding housing subspaces of the UAV body 10, respectively. In some embodiments, the remote-controller component of the remote controller 20 may include a remote-controller body and a remote-controller antenna. The housing space 110 of the UAV body 10 may include a first housing subspace arranged at be in the middle of the UAV body 10, and second housing subspaces arranged at both sides of the first housing subspace. The remote-controller body may be housed at the first housing subspace, and the remote-controller antenna may be housed at the second housing subspaces. In these embodiments, the remote controller 20 of the UAV system 1 can be conveniently housed at the UAV body 10 without additionally increasing volume of the UAV body 10.

In some embodiments, the UAV body 10 may include a battery and/or a gimbal, and the remote controller 20 may include a storage space to house the battery and/or the gimbal of the UAV body 10. When the UAV system is disassembled and packed, the battery and/or the gimbal of the UAV body 10 may be first housed at the remote controller 20, and then the remote controller 20 may be housed at the UAV body 10. Such arrangement can further improve housing efficiency.

Besides the example embodiments described above, in some embodiments, when the first device is the UAV body and the second device is the remote controller for controlling the UAV body (e.g., the remote controller is placed at the UAV body), a self-adhesive hook/loop fastener may also be provided at the UAV body, and a corresponding loop/hook fastener may be provided at the remote controller, such that the remote controller can be attached to the UAV body. In some embodiments, a strap may be provided at the UAV body for fastening the remote controller to the UAV body. In some embodiments, a magnet may be provided at the UAV body, and a corresponding opposing magnet may be provided at the remote controller, thus the remote controller can be attached to the UAV body.

The following embodiments will illustrate the UAV system consistent with the present disclosure by taking the UAV body placed at the remote controller as an example.

In some embodiments, the second device may be the UAV body, and the first device may be the remote controller for controlling the UAV body, i.e, the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

In some embodiments, the housing space of the remote controller may be the housing groove, and the UAV body may be housed and held at the housing groove. The retaining structure may include snapping members arranged at end portions of two opposing groove sidewalls of the housing groove, and snapping slots arranged at the two opposing sidewalls of the UAV body. The snapping slots may be configured to match the snapping members on the housing groove of the remote controller. Further, the end portions of the two opposing groove sidewalls of the housing groove of the remote controller may include two snapping members, respectively. Correspondingly, the two opposing sidewalls of the UAV body may include two snapping slots, respectively.

The UAV body may be snapped and fixed to the snapping members of the housing groove of the remote controller via the snapping members, thus being housed and held at the housing groove of the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace, and the propeller assembly of the UAV body may be disassembled from the fuselage and housed at the second housing subspaces. In some embodiments, the fuselage of the UAV body may be housed at the first housing subspace, whereas a battery and/or a gimbal of the UAV body may be disassembled from the fuselage and housed at the second housing subspaces. In these embodiments, the UAV body can be conveniently housed at the remote controller without additionally increasing volume of the remote controller.

In some embodiments, the second device may be the UAV body, and the first device may the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, such that the UAV body and the remote controller can be integrally housed together for ease of carrying.

In some embodiments, the housing space of the remote controller may be the housing groove, and the UAV body may be housed and held at the housing groove. The retaining structure may include first sliding slots arranged at inner walls of two opposing groove sidewalls of the housing groove, and first sliding ribs arranged at the two opposing sidewalls of the UAV body. The first sliding ribs may be configured to match the first sliding slots of the housing groove of the remote controller. Further, the inner walls of the two opposing groove sidewalls of the housing groove may each include a first sliding slot, arranged along the length direction of the groove sidewalls. Correspondingly, the two opposing sidewalls of the UAV body may each include a first sliding rib, arranged along the length direction of the UAV body.

The UAV body may slide in or out of the first sliding slots of the housing groove of the remote controller via the first sliding ribs, thus being housed and held at the housing groove of the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace, and the propeller assembly of the UAV body may be disassembled from the fuselage and housed at the second housing subspaces. In some embodiments, the fuselage of the UAV body may be housed at the first housing subspace, whereas a battery and/or a gimbal of the UAV body may be disassembled from the fuselage and housed at the second housing subspaces. In these embodiments, the UAV body can be conveniently housed at the remote controller without additionally increasing volume of the remote controller.

In some embodiments, the second device may be the UAV body, and the first device may the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

In some embodiments, the housing space of the remote controller may be the housing groove, and the UAV body may be housed and held at the housing groove. The retaining structure may include a cover plate movably connected to the remote controller and configured to cover an opening of the housing groove of the remote controller. Further, the retaining structure may also include second sliding slots arranged at end portions of two opposing groove sidewalls of the housing groove of the remote controller, and second sliding ribs arranged at two opposing sides of the cover plate. The second sliding ribs may be configured to match the second sliding slots of the housing groove of the remote controller. In some embodiments, the end portions of the two opposing groove sidewalls of the housing groove of the remote controller may each include a second sliding slot, arranged along the length direction of the groove sidewalls. Correspondingly, the two opposing sides of the cover plate may each include a second sliding rib, arranged along the length direction of the cover plate.

After the UAV body is housed at the housing groove of the remote controller, the opening of the housing groove of the remote controller can be closed or opened, by sliding the second sliding ribs of the cover plate in or out of the second sliding slots of the housing groove of the remote controller, thus the UAV body can be retained at the housing groove of the remote controller or be exposed and removed from the housing groove of the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace, and the propeller assembly of the UAV body may be disassembled from the fuselage and housed at the second housing subspaces, respectively. In some embodiments, the fuselage of the UAV body may be housed at the first housing subspace, whereas a battery and/or a gimbal of the UAV body may be disassembled from the fuselage and housed at the second housing subspaces. In these embodiments, the UAV body can be conveniently housed at the remote controller without additionally increasing volume of the remote controller.

In some embodiments, the second device may be the UAV body, and the first device may the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

In some embodiments, the housing space may be the housing groove, and the UAV body may be housed and held at the housing groove. The retaining structure may include a cover plate movably connected to the remote controller and configured to cover an opening of the housing groove of the remote controller. Further, the retaining structure may also include a pivot shaft arranged at one end of the housing groove of the remote controller, and the cover plate may be rotatably connected to the pivot shaft. In some embodiments, the pivot shaft may be arranged at the end of the housing groove next to the middle of the remote controller.

After the UAV body is housed at the housing groove of the remote controller, the cover plate can be turned upwards or downwards to open or close the opening of the housing groove of the remote controller, thus the UAV body can be retained at the housing groove of the remote controller or be exposed and removed from the housing groove of the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace. The propeller assembly of the UAV body may be disassembled from the fuselage and housed at the second housing subspaces, respectively. In some embodiments, the fuselage of the UAV body may be housed at the first housing subspace, whereas a battery and/or a gimbal of the UAV body may be disassembled from the fuselage and housed at the second housing subspaces, respectively. In these embodiments, the UAV body can be conveniently housed at the remote controller without additionally increasing volume of the remote controller.

In some embodiments, the second device may be the UAV body, and the first device may the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

The retaining structure may also include a drawer-box structure housed at the remote controller, and the housing space may be arranged at the drawer-box structure. One side of the remote controller may include an opening, through which the drawer-box structure may be pulled from or pushed back to the remote controller.

After the UAV body is housed at the housing space of the drawer-box structure, the drawer-box structure can be pulled from or pushed back to the remote controller via the opening, thus the UAV body can be removed from or retained at the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace. The propeller assembly of the UAV body may be disassembled from the fuselage and housed at the second housing subspaces, respectively.

In some embodiments, the second device may be the UAV body, and the first device may the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

In some embodiments, the housing space may be formed to the remote controller. The retaining structure may include third sliding slots arranged at inner walls of two opposing sidewalls of the remote controller, and third sliding ribs arranged at the two opposing sidewalls of the UAV body. The third sliding ribs may be configured to match the third sliding slots of the inner walls of the two opposing sidewalls of the remote controller. One side of the remote controller may also include an opening, through which the UAV body may be pulled from or pushed back to the housing space of the remote controller. Further, the inner walls of the two opposing sidewalls of the remote controller may each include a third sliding slot, arranged along the length direction of the remote controller. Correspondingly, the two opposing sidewalls of the UAV body may each include a sliding rib, arranged along the length direction of the UAV body.

Pushing the UAV body back to the housing space of the remote controller via the opening can retain the UAV body to the remote controller. Pulling the UAV body from the housing space of the remote controller via the opening can withdraw the UAV body from the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace. The propeller assembly of the UAV body may be disassembled from the fuselage and housed at the second housing subspaces, respectively. In some embodiments, the fuselage of the UAV body may be housed at the first housing subspace, whereas a battery and/or a gimbal of the UAV body may be disassembled from the fuselage and housed at the second housing subspaces. In these embodiments, the UAV body can be conveniently housed at the remote controller without additionally increasing volume of the remote controller.

In some embodiments, the second device may be the UAV body, and the first device may be the remote controller for controlling the UAV body, e.g., the UAV body may be placed at the remote controller. The UAV body may maintain wireless communication with the remote controller. The remote controller may include a housing space. The UAV body may be housed and held at the housing space of the remote controller via the retaining structure, thus the UAV body and the remote controller can be integrally housed together for ease of carrying.

In some embodiments, the remote controller can be locally or globally deformed. After the remote controller is deformed to release the housing space, the UAV body can be housed and held at the remote controller.

In some embodiments, the UAV body may include a first charging interface, and the remote controller may include a second charging interface to pair and connect with the first charging interface of the UAV body. When the UAV body is housed at the remote controller, the second charging interface of the remote controller may be connected to the first charging interface of the UAV body. When a battery capacity of the UAV body is insufficient, due to a lower power consumption of the remote controller, a battery of the remote controller can charge a battery of the UAV body. In some embodiments, when a battery capacity of the remote controller is insufficient, due to the larger battery capacity of the UAV body, the battery of the UAV body can charge the battery of the remote controller.

In some embodiments, the UAV body may include a first data interface, and the remote controller may include a second data interface to pair and connect with the first data interface. When the UAV body is housed at the remote controller, the second data interface of the remote controller may be connected with the first data interface of the UAV body, such that data can be transmitted between the UAV body and the remote controller. For example, data synchronization can be achieved among specific devices (e.g., a black box) of the UAV body and the remote controller. In some embodiments, the UAV body may transmit the data (e.g., flight data, photographed photos and videos, etc.) to the remote controller, and then the remote controller 20 (via the mobile device or a private network) may synchronize with the cloud and transmit the data to the cloud.

In some embodiments, the UAV body may include a plurality of UAV components that are detachable from each other, and the housing space of the remote controller may include a plurality of housing subspaces corresponding to the plurality of UAV components of the UAV body. The plurality of UAV components of the UAV body may be housed at the corresponding housing subspaces of the remote controller, respectively. In some embodiments, the UAV components of the UAV body may include a fuselage, a propeller assembly connected to the fuselage, and a battery and/or a gimbal connected to the fuselage. These UAV components can be disassembled and placed at the corresponding the housing subspaces of the remote controller. For example, in some embodiments, the housing space of the remote controller may include a first housing subspace arranged at be in the middle of the remote controller, and second housing subspaces arranged at both sides of the first housing subspace. The fuselage of the UAV body may be housed at the first housing subspace. The propeller assembly of the UAV body may be disassembled from the fuselage and housed at the second housing subspaces, respectively. In some embodiments, the fuselage of the UAV body may be housed at the first housing subspace, whereas a battery and/or a gimbal of the UAV body may be disassembled from the fuselage and housed at the second housing subspaces, respectively. In these embodiments, the UAV body can be conveniently housed at the remote controller without additionally increasing volume of the remote controller.

Besides the above embodiments, in some embodiments, when the second device is the UAV body and the first device is the remote controller for controlling the UAV body (e.g., the UAV body is placed at the remote controller), a self-adhesive hook/loop fastener may also be provided at the remote controller, and a corresponding loop/hook fastener may be provided at the UAV body, thus the UAV body can be attached to the remote controller. In some embodiments, a strap may be provided at the remote controller fastening the UAV body to the remote controller. In some embodiments, a magnet may be provided at the remote controller, and a corresponding opposing magnet may be provided at the UAV body, thus the UAV body can be attached to the remote controller.

It should be noted that, in this specification, relational terms such as first and second, etc., are only used to distinguish one entity or operation from another entity or operation, and do not necessarily require or imply any actual relationship or order present among these entities or operations. The terms “include”, “comprise” or any other variations thereof are intended to cover a non-exclusive inclusion, such that a process, a method, an article, or an apparatus that comprise a series of elements include not only those elements, but also other elements that are not specifically listed or elements that are inherent to such process, method, article or apparatus. In the absence of any more limitations, the elements defined by the sentence “include one . . . ” do not exclude that there are other identical elements in the process, method, article or apparatus that include the elements.

The description of the embodiments is provided at illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and features disclosed herein.

What is claimed is:

1. An unmanned aerial vehicle (UAV) system comprising:
a first device comprising a housing space;
a second device configured to be housed and held at the housing space; and
a retaining structure configured to hold the second device at the housing space.

2. The UAV system according to claim 1, wherein:
the first device comprises a UAV body; and
the second device comprises a remote controller configured to control the UAV body.

3. The UAV system according to claim 2, wherein:
the UAV body comprises a fuselage and a propeller assembly connected to the fuselage; and
the housing space is arranged the fuselage.

4. The UAV system according to claim 2, wherein:
the UAV body comprises at least one of a battery or a gimbal; and
the remote controller comprises a storage space configured to store the at least one of the battery or the gimbal.

5. The UAV system according to claim 1, wherein:
the second device comprises a UAV body; and
the first device comprises a remote controller configured to control the UAV body.

6. The UAV system according to claim 1, wherein:
the housing space comprises a housing groove;
the second device is housed at the housing groove; and
the retaining structure comprises:
snapping members arranged at end portions of two opposing groove sidewalls of the housing groove, respectively; and
snapping slots arranged at two opposing sidewalls of the second device, respectively, the snapping slots being configured to match the snapping members.

7. The UAV system according to claim 1, wherein:
the housing space comprises a housing groove;
the second device is housed at the housing groove; and
the retaining structure comprises:
sliding slots arranged at inner sides of two opposing groove sidewalls of the housing groove, respectively; and
sliding ribs arranged at two opposing sidewalls of the second device, the sliding slots being configured to match the sliding ribs.

8. The UAV system according to claim 7, wherein the sliding slots are arranged along a length direction of the groove sidewalls.

9. The UAV system according to claim 1, wherein:
the housing space comprises a housing groove;
the second device is housed at the housing groove; and
the retaining structure comprises a cover plate movably connected to the first device and configured to cover an opening of the housing groove.

10. The UAV system according to claim 8, wherein the retaining structure further comprises:
sliding slots arranged at end portions of two opposing groove sidewalls of the housing groove, respectively; and
sliding ribs arranged at two opposing sides of the cover plate, respectively, the sliding ribs being configured to match the sliding slots.

11. The UAV system according to claim 10, wherein the sliding slots are configured along a length direction of the groove sidewalls.

12. The UAV system according to claim 9, wherein the retaining structure further comprises a pivot shaft arranged at one end of the housing groove, and the cover plate is rotatably connected to the pivot shaft.

13. The UAV system according to claim 1, wherein:
the first device further comprises an opening at one side of the first device;
the retaining structure further comprises a drawer-box structure housed at the first device, and configured to be pulled from or pushed back to the first device via the opening; and
the housing space is arranged at the drawer-box structure.

14. The UAV system according to claim 1, wherein:
the housing space is formed in the first device;
the retaining structure comprises:
sliding slots arranged at inner walls of two opposing sidewalls of the first device, respectively; and
sliding ribs arranged at two opposing sidewalls of the second device, respectively, the sliding ribs being configured to match the sliding slots;
the first device further comprises an opening arranged at one side of the first device; and
the second device is configured to be pulled from or pushed back to the housing space via the opening.

15. The UAV system according to claim 14, wherein the sliding slots are arranged along a length direction of the first device.

16. The UAV system according to claim 1, wherein:
the first device comprises a first charging interface; and
the second device comprises a second charging interface configured to be connected with the first charging interface.

17. The UAV system according to claim 1, wherein:
the first device comprises a first data interface; and
the second device comprises a second data interface configured to be connected with the first data interface.

18. The UAV system according to claim 1, wherein:
the second device comprises a plurality of components that are detachable from each other;
the housing space comprises a plurality of housing subspaces corresponding to the plurality of components; and
the plurality of components are housed at the plurality of housing subspaces, respectively.

19. The UAV system according to claim 18, wherein:
the second device comprises a UAV body;
the first device comprises a remote controller configured to control the UAV body;
the plurality of components of the second device comprise a fuselage of the UAV body and a propeller assembly of the UAV body that is connected with the fuselage.

20. The UAV system according to claim 19, wherein the plurality of components further comprise at least one of a battery or a gimbal connected with the fuselage.
